(19) United States
(12) Patent Application Publication
(10) Pub. No.: US 2014/0307600 A1
(43) Pub. Date: Oct. 16, 2014

(54) METHOD, APPARATUS, AND COMPUTER PROGRAM PRODUCT FOR REDUCING POWER CONSUMPTION FOR WIRELESS COMMUNICATIONS

(71) Applicant: NOKIA CORPORATION, Espoo (FI)

(72) Inventors: Dan DUMITRESCU, Espoo (FI); Mikko LAANINEN, Helsinki (FI); Miikka TIKANDER, Helsinki (FI); Ji SHIPING, Espoo (FI)

(73) Assignee: Nokia Corporation, Espoo (FI)

(21) Appl. No.: 13/862,552

(22) Filed: Apr. 15, 2013

(51) Int. Cl. H04W 52/02; H04W 4/00

(52) U.S. Cl. CPC H04W 52/0245; H04W 4/008
USPC 370/311

(57) ABSTRACT

Method, apparatus, and computer program product example embodiments enable wireless communication devices to reduce power consumption. In example embodiments, a method comprises receiving, by a communication controller in a wireless communication device, proximity settings, from a host in the wireless communication device, for determining proximity of a peer wireless communication device, based on received signal strength indication (RSSI) of wireless signals received from the peer wireless communication device; analyzing, by the communication controller, real-time received signal strength indication (RSSI) measurement data of wireless signals received from the peer wireless communication device; and sending, by the communication controller, to the host in the wireless communication device, proximity events resulting from the analysis of the real-time received signal strength indication (RSSI) measurement data, based on the received proximity settings for determining proximity of the peer wireless communication device.

### FIELD

The field of the invention relates to wireless communication and more particularly to reducing power consumption in wireless communication devices.

### BACKGROUND

Perhaps the best-known example of wireless personal area network (PAN) technology is Bluetooth Standard, which operates in the 2.4 GHz ISM band. Bluetooth is a short-range radio network, originally intended as a cable replacement. Bluetooth Technical Specifications are published by the Bluetooth SIG, Inc. Bluetooth Specification version 2.0+EDR, published Oct. 15, 2004 has the original functional characteristics of the first version Bluetooth Basic Rate (BR) and adds the Enhanced Data Rate (EDR) feature. Bluetooth Specification version 2.1+EDR, published Jul. 26, 2007 for Basic Rate/Enhanced Data Rate (BR/EDR), added definitions for new features: Encryption Pause Resume, Erroneous Data reporting, Extended Inquiry Response, Link Supervision Timeout Event, Packet Boundary Flag, Secure Simple Pairing, Sniff Subrating. Bluetooth Specification version 3.0+HS, published Apr. 21, 2009, updated the standard to integrate the Alternate MAC/PHY and Unicast Connectionless Data features.

On Apr. 20, 2009, Bluetooth SIG presented the new Bluetooth Low Energy protocol. Bluetooth Low Energy (LE) is a communication protocol directed to optimize power consumption of devices while being connected to other devices. The Bluetooth Low Energy packets include a preamble used for radio synchronization, an access address used for physical link identification, a shorter protocol data unit (PDU) to carry the payload data and the PDU header information, and a cyclic redundancy code (CRC) to ensure correctness of the data in the PDU.

On Jun. 30, 2010, the Bluetooth SIG published the Bluetooth Core Specification, Version 4.0 (incorporated herein by reference), which includes the Bluetooth Low Energy (LE) protocol for products that require lower power consumption, lower complexity, and lower cost than would be possible using the BR/EDR protocol. Bluetooth LE is designed for applications requiring lower data rates and shorter duty cycles, with a very-low power idle mode, a simple device discovery, and short data packets. Bluetooth LE devices employ a star topology, where one device serves as a master for a plurality of slave devices, the master dictating connection timing by establishing the start time of the first connection event and the slave devices transmitting packets only to the master upon receiving a packet from the master. According to Bluetooth LE communication protocol all connections are point-to-point connections between two devices (the master and the slave).

### SUMMARY

Method, apparatus, and computer program product example embodiments enable wireless communication devices to reduce power consumption.

According to an example embodiment of the invention, a method comprises:

receiving, by a communication controller in a wireless communication device, proximity settings from a host in the wireless communication device, for determining proximity of a peer wireless communication device, based on received signal strength indication (RSSI) of wireless signals received from the peer wireless communication device;

analyzing, by the communication controller, real-time received signal strength indication (RSSI) measurement data of wireless signals received from the peer wireless communication device; and

sending, by the communication controller, to the host in the wireless communication device, proximity events resulting from the analysis of the real-time received signal strength indication (RSSI) measurement data, based on the received proximity settings for determining proximity of the peer wireless communication device.

According to an example embodiment of the invention, a method comprises:

wherein the communication controller, sends only critical proximity events to the host in the wireless communication device, resulting from the analysis of the real-time received signal strength indication (RSSI) measurement data, based on the received proximity settings for determining proximity of the peer wireless communication device.

According to an example embodiment of the invention, a method comprises:

wherein the communication controller is a Bluetooth Low Energy logical link layer controller.

According to an example embodiment of the invention, a method comprises:

wherein the critical proximity events are host control interface (HCI) events.

According to an example embodiment of the invention, a method comprises:

wherein the host control interface (HCI) event is a proximity notification event reporting a status change in proximity based on an RSSI threshold indicating either an in-range proximity or an out-of-range proximity.

According to an example embodiment of the invention, a method comprises:

wherein the communication controller receives the proximity settings from the host using a host control interface (HCI command.

According to an example embodiment of the invention, an apparatus comprises:

at least one processor;

at least one memory including computer program code;

the at least one memory and the computer program code configured to, with the at least one processor, cause the apparatus at least to:

receive, in a wireless communication device, proximity settings from a host in the wireless communication device, for determining proximity of a peer wireless communication device, based on received signal strength indication (RSSI) of wireless signals received from the peer wireless communication device;

analyze real-time received signal strength indication (RSSI) measurement data of wireless signals received from the peer wireless communication device; and

send to the host in the wireless communication device, proximity events resulting from the analysis of the real-time received signal strength indication (RSSI) measurement data, based on the received proximity settings for determining proximity of the peer wireless communication device.

According to an example embodiment of the invention, an apparatus comprises:

wherein the communication controller, sends only critical proximity events to the host in the wireless communication device, resulting from the analysis of the real-time received signal strength indication (RSSI) measurement data, based on the received proximity settings for determining proximity of the peer wireless communication device.

According to an example embodiment of the invention, an apparatus comprises:

wherein the apparatus is a Bluetooth Low Energy logical link layer controller.

According to an example embodiment of the invention, an apparatus comprises:

wherein the critical proximity events are host control interface (HCI) events.

According to an example embodiment of the invention, an apparatus comprises:

wherein the host control interface (HCI) events are proximity notification events reporting status change in proximity based on an RSSI threshold proximity setting indicating either an in-range proximity or an out-of-range proximity.

According to an example embodiment of the invention, an apparatus comprises:

wherein the apparatus receives the proximity settings from the host using a host control interface (HCI) command.

According to an example embodiment of the invention a computer program product comprises computer executable program code recorded on a computer readable non-transitory storage medium, the computer executable program code comprising:

code for receiving, by a communication controller in a wireless communication device, proximity settings from a host in the wireless communication device, for determining proximity of a peer wireless communication device, based on received signal strength indication (RSSI) of wireless signals received from the peer wireless communication device;

code for analyzing, by the communication controller, real-time received signal strength indication (RSSI) measurement data of wireless signals received from the peer wireless communication device; and

code for sending, by the communication controller, to the host in the wireless communication device, proximity events resulting from the analysis of the real-time received signal strength indication (RSSI) measurement data, based on the received proximity settings for determining proximity of the peer wireless communication device.

According to an example embodiment of the invention a computer program product comprises:

wherein the communication controller, sends only critical proximity events to the host in the wireless communication device, resulting from the analysis of the real-time received signal strength indication (RSSI) measurement data, based on the received proximity settings for determining proximity of the peer wireless communication device.

According to an example embodiment of the invention a computer program product comprises:

wherein the communication controller is a Bluetooth Low Energy logical link layer controller.

According to an example embodiment of the invention a computer program product comprises:

wherein the critical proximity events are host control interface (HCI) events.

According to an example embodiment of the invention a computer program product comprises:

wherein the host control interface (HCI) event is a proximity notification event reporting a status change in proximity based on an RSSI threshold indicating either an in-range proximity or an out-of-range proximity.

According to an example embodiment of the invention a computer program product comprises:

wherein the communication controller receives the proximity settings from the host using a host control interface (HCI command.

Accordingly, wireless communication devices may reduce power consumption in wireless communication devices.

### DESCRIPTION OF THE FIGURES

FIG. 1 is an example network diagram of two Bluetooth LE-enabled smart phones, with a first smart phone receiving a Bluetooth LE packet from the second smart phone and determining the proximity based on received signal strength indication (RSSI), in accordance with at least one embodiment of the present invention.

FIG. 2 is an example functional block diagram of the first Bluetooth LE-enabled smart phone, illustrating the host application, the Bluetooth LE protocol stack, the phone protocol stack, and the battery in accordance with at least one embodiment of the present invention.

FIG. 3 is a more detailed example functional block diagram of the first Bluetooth LE-enabled smart phone, illustrating the RSSI supervision and handling functions of the Proximity Monitor implemented in the Bluetooth LE logical link controller, in accordance with at least one embodiment of the present invention.

FIG. 4 is an example embodiment of a flow diagram of a method performed by the Bluetooth LE logical link controller, in accordance with an example embodiment of the invention.

FIG. 5 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with an example embodiment of the invention.

### DISCUSSION OF EXAMPLE EMBODIMENTS OF THE INVENTION

This section is organized into the following topics:

I. Device Discovery In Wireless Short-Range Communication Networks

II. Bluetooth™ Low Energy (LE) Technology

III. Bluetooth™ RSSI

IV. Bluetooth™ Host Controller Interface

V. Bluetooth LE Proximity Profile

VI. Reducing Power Consumption For Bluetooth LE Proximity Profile

I. Device Discovery In Wireless Short-Range Communication Networks

Short-range communication technologies provide communication solutions appropriate for many data applications, without the cost, traffic and legislative concerns of longer-range communication technologies. Popular short-range communication technologies include Bluetooth basic rate/enhanced data rate (BR/EDR), Bluetooth Low Energy (LE), IEEE 802.11 wireless local area network (WLAN), Wireless Universal Serial Bus (WUSB), Ultra Wide-band (UWB), ZigBee (IEEE 802.15.4, IEEE 802.15.4a), and near field communication technologies, such as radio frequency identification (RFID) and near field communication (NFC) technology that enable contactless identification and interconnection of wireless devices. Bluetooth Low Energy (LE) Technology provides an example of device discovery in wireless short-range communication networks.

II. Bluetooth Low Energy (LE) Technology

The Bluetooth™ Core Specification, Version 4.0 includes the Bluetooth LE protocol for products that require lower power consumption, lower complexity, and lower cost than would be possible using the BR/EDR protocol. Bluetooth LE is designed for applications requiring lower data rates and shorter duty cycles, with a very-low power idle mode, a simple device discovery, and short data packets. Bluetooth LE devices may employ a star topology, where one device serves as a master for a plurality of slave devices, the master dictating connection timing by establishing the start time of the first connection event and the slave devices transmitting packets only to the master upon receiving a packet from the master. According to Bluetooth LE communication protocol all connections are point-to-point connections between two devices (the master and the slave).

The Bluetooth LE protocol allows a star network topology in connections, where one device serves as a master for a plurality of slave devices. The master device dictates the connection timing and communication operations of the one or more slave devices. Bluetooth LE communicates over a total of 40 RF channels, each having a bandwidth of 2 MHz. Data communication between Bluetooth LE devices occurs in 37 pre-specified data channels, of the 40 RF channels. All data connection transmissions occur in connection events wherein a point-to-point connection is established between the master device and a slave device. In the Bluetooth LE protocol, a slave device provides data through Bluetooth LE communication to the master device to which it is connected. The remaining 3 channels, of the 40 RF channels, are advertising channels used by devices to advertise their existence and capabilities. The Bluetooth LE protocol defines a unidirectional connectionless broadcast mode on the advertising channels.

The Link Layer provides a state machine with the following five states: Standby State, Advertising State, Scanning State, Initiating State, and Connection State. The Link Layer state machine allows only one state to be active at a time. The Link Layer in the Standby State does not transmit or receive any packets and can be entered from any other state. The Link Layer in the Advertising State will be transmitting advertising channel packets and possibly listening to and responding to responses triggered by these advertising channel packets. A device in the Advertising State is known as an advertiser. The Advertising State can be entered from the Standby State. The Link Layer in the Scanning State will be listening for advertising channel packets from devices that are advertising. A device in the Scanning State is known as a scanner. The Scanning State can be entered from the Standby State. The Link Layer in the Initiating State will be listening for advertising channel packets from a specific device and responding to these packets to initiate a connection with that specific device. A device in the Initiating State is known as an initiator. The Initiating State can be entered from the Standby State. The Connection State of the Link Layer may be entered either from the Initiating State or the Advertising State. A device in the Connection State is known as being in a connection over a data channel. Within the Connection State, two roles are defined: the Master Role and the Slave Role. When a device in the Initiating State, enters the Connection State, it is in the Master Role, it exchanges data packets with a slave device in a data channel, and it defines the timings of transmissions. When a device in the Advertising State, enters the Connection State, it is in the Slave Role and exchanges data packets with a master device in a data channel, wherein the master device defines the timings of transmissions.

The Bluetooth LE radio operates in the unlicensed 2.4 GHz ISM band, in the same manner as does the Basic Rate/Enhanced Data Rate (BR/EDR) radio. Bluetooth LE supports very short data packets, from 8 octets to a maximum of 27 octets, giving it a low duty cycle. Bluetooth LE employs a frequency hopping transceiver with many frequency hopping spread spectrum (FHSS) carriers, with a bit rate of 1 Megabit per second (Mb/s).

Bluetooth LE employs two multiple access schemes: Frequency division multiple access (FDMA) and time division multiple access (TDMA). Forty (40) physical channels, separated by 2 MHz, are used in the FDMA scheme. Three (3) are used as advertising channels and 37 are used as data channels. A TDMA based polling scheme is used in which one device transmits a packet at a predetermined time and a corresponding device responds with a packet after a predetermined interval.

The physical channel is sub-divided into time units known as events. Data is transmitted between Bluetooth LE devices in packets that are positioned in these events. There are two types of events: Advertising and Connection events.

Devices that transmit advertising packets on the advertising Physical Layer (PHY) channels are referred to as advertisers. Devices that receive advertising on the advertising channels without the intention to connect to the advertising device are referred to as scanners. Devices that form a connection to another device by listening for connectable advertising packets, are referred to as initiators. Transmissions on the advertising PHY channels occur in advertising events.

In the Bluetooth™ Core Specification, Version 4.0, there are four advertising event types: connectable undirected advertising (ADV_IND), connectable directed advertising (ADV_DIRECT_IND), scannable undirected advertising (ADV_SCAN_IND), and non-connectable undirected advertising (ADV_NONCONN_IND). At the start of each advertising event, the advertiser sends an advertising packet corresponding to the advertising event type. The header of the advertising channel packet identifies the packet type in a four-bit PDU Type field encoding. There are seven values currently assigned to the four-bit PDU Type field, ranging from 0000 to 0110, with the values 0111 to 1111 being reserved for future use.

The scanner device, also referred to as the initiator device, that receives the advertising packet, may make a connect request (CONNECT_REQ) to the advertiser device on the same advertising PHY channel. The CONNECT_REQ request includes fields for access address AA, CRC, WinSize, WinOffset, Interval, Latency, Timeout, ChannelMap, Hop count, and sleep clock accuracy SCA. The four-bit PDU Type field in the header of the CONNECT_REQ advertising channel packet, is 0101. When the advertiser device accepts the CONNECT_REQ request, a point-to-point connection results between the scanner/initiator device that becomes the master device, and the advertiser device that becomes the slave device in a piconet. The master and the slave devices know at what time and in which frequency the connection is in operation. The data channel changes between every connection event and the start of connection events are spaced regularly with the connection interval that is provided in the CONNECT_REQ packet.

In the connectable undirected advertising (ADV_IND) channel packet, the ADV_IND PDU has a payload field containing AdvA and AdvData fields. The AdvA field contains the advertiser's public or random device address and the AdvData field may contain Advertising data from the advertiser's host. The PDU may be used in connectable undirected advertising events. The four-bit PDU Type field in the header of the ADV_IND advertising channel packet, is 0000.

In the connectable directed advertising (ADV_DIRECT_IND) channel packet, the ADV_DIRECT_IND PDU has the payload field containing AdvA and InitA fields. The AdvA field contains the advertiser's public or random device address. The InitA field is the address of the device to which this PDU is addressed. The InitA field may contain the initiator's public or random device address. The PDU may be used in connectable directed advertising events. This packet may not contain any host data. The four-bit PDU Type field in the header of the ADV_DIRECT_IND advertising channel packet, is 0001.

In a non-connectable undirected event type advertising channel packet, ADV_NONCONN_IND, a scanner device is allowed to receive information in the advertising channel packet, but scanner devices are not allowed to transmit anything in the advertising channels upon receiving the ADV_NONCONN_IND advertising channel packets. When the non-connectable undirected event type is used, non-connectable advertising indications ADV_NONCONN_IND packets are sent by the Link Layer. The non-connectable undirected event type allows a scanner to receive information contained in the ADV_NONCONN_IND from the advertiser. The advertiser may either move to the next used advertising channel index or close the advertising event after each ADV_NONCONN_IND that is sent. The four-bit PDU Type field in the header of the ADV_NONCONN_IND advertising channel packet, is 0010.

In the scannable undirected advertising (ADV_SCAN_IND) channel packet, the ADV_SCAN_IND PDU has the payload field containing AdvA and AdvData fields. The AdvA field contains the advertiser's public or random device address. The PDU may be used in scannable undirected advertising events. The AdvData field may contain Advertising Data from the advertiser's host. The four-bit PDU Type field in the header of the ADV_SCAN_IND advertising channel packet, is 0110.

In the Bluetooth™ Core Specification, Version 4.0, if the advertiser is using a connectable advertising event, a scanner/initiator may make a connection request using the same advertising PHY channel on which it received the connectable advertising packet. The advertising event is ended and connection events begin if the advertiser receives and accepts the request for a connection to be initiated. Once a connection is established, the scanner/initiator becomes the master device in a piconet and the advertising device becomes the slave device. Within a connection event, the master and slave alternate sending data packets using the same data PHY channel.

According to the Bluetooth Specification V4.0, Bluetooth LE device discovery involves different operational processes for devices with different roles. In particular:
Slave Device, being an advertiser, performs an advertising process during which the device repeatedly enters Advertising Events. The interval of each start of Advertising Event, Ta, composes of a fixed-length “advInterval” and a random-length “advDelay”. In Advertising Event, the device sends advertising Packet Data Units (PDUs) in broadcasting channel 37, 38 and 39, respectively.
Master Device, being an initiator/scanner, performs the initiating/scanning process. An initiating/scanning process consists of repeated “scanInterval”, each of which contains a “scanWindow”. In a different “scanWindow”, the device changes the RF module to receive the state and listens to advertising PDUs on different broadcasting channels; while out of the “scanWindow”, it does routine scheduling, or turns off the RF module.

If any advertising PDU is received by an initiator/scanner, it means the initiator successfully discovers the advertising device. For the initiator, it can directly send back a “CONN_REQ” to establish a connection with that advertiser. For a scanner, it can send out a “SCAN_REQ” to ask for more information from that advertiser.

Example non-limited use cases for Bluetooth LE technology include sports and fitness, security and proximity and smart energy. Bluetooth LE technology is designed for devices to have a battery life of up to one year such as those powered by coin-cell batteries. These types of devices include watches that will utilize Bluetooth LE technology to display Caller ID information and sports sensors that will be utilized to monitor the wearer's heart rate during exercise. The Medical Devices Working Group of the Bluetooth SIG is also creating a medical devices profile and associated protocols to enable Bluetooth applications for Bluetooth LE devices.

A Bluetooth LE advertising channel may be shared by any number of Bluetooth LE devices. Any number of Bluetooth LE devices may transmit advertising packets while sharing the same three advertising PHY channels. In high-density environments, however, since there are a large number of nodes to be discovered, the probability of broadcasting conflict will inevitably increase, causing network access time to increase, and also lowering the energy efficiency of the whole network.

III. Bluetooth™ RSSI

The received signal strength indicator (RSSI) is a measurement of the power present in a received radio signal. Bluetooth receiver circuits may include an RSSI detector circuit to measure the strength of an incoming signal and generate an output representing the signal strength. For example, the received RF signal may be amplified and downconverted to an intermediate frequency (IF); then channel selection is performed on the IF signal, and the power of the IF signal in the selected channel is measured as the receiver signal strength indicator (RSSI) value. If the Bluetooth receiver circuit supports RSSI, the accuracy may be +/−6 dBm or better.

RSSI Monitoring of Bluetooth LE Packets

During Bluetooth discovery in Bluetooth LE, before a connection is created, the RSSI may be measured from advertising packets received in broadcasting channel 37, 38, or 39, when they are received by a scanning device, if enabled by the host.

When the controller receives an advertising packet, an HCI LE Advertising Report event is sent by the controller to the host application. The HCI LE Advertising Report event indicates that a Bluetooth device or multiple Bluetooth devices have been detected during an active scan or during a passive scan. The HCI LE Advertising Report event includes a parameter N that indicates the RSSI of the received packet, with N being one octet representing the magnitude of the RSSI, with a range in units of dBm of −127≦N≦+20. This event will be sent from the Controller to the Host as soon as an advertising packet from a remote device is received. The RSSI parameter is measured during the receipt of the advertising packet. This event contains RSSI and advertising packet data for the remote device.

RSSI Monitoring of Data Packets Received Over a Connection

After the discovery phase is completed, once a Bluetooth LE device is connected to another Bluetooth device, the received signal strength indication (RSSI) may be used by a receiving device to monitor the received power level of the data communication packets received over the connection. The RSSI value is calculated from received packet in the Bluetooth physical layer, and may be read by the host application for example through the host controller interface (HCI) Read RSSI command, for example once per second.

The Read RSSI Command will read the value of the received signal strength indication (RSSI) for data communication packets received over the connection to another Bluetooth LE controller. The RSSI value is referenced with respect to a Connection_Handle that identifies the connection and is assigned when the connection is created. The Connection_Handle is used by the Bluetooth controller to determine which set of buffers to use and the logical link over which the data is to be sent.

Measuring Pathloss with the RSSI and the TX Power Level

The TX Power Level data field in the Bluetooth LE advertising packet indicates the transmitted power level of the advertising packets at the transmitter of the sending device. The TX Power Level is reported to the host in response to the HCI LE Read Advertising Channel Tx Power Command. The TX Power Level data field may be used to calculate path loss of a received packet when the receiving device measures the RSSI of the received advertising packet, using the following equation:

pathloss=Tx Power Level−RSSI of the inquiry response packet

For example, if Tx Power Level=+4 (dBm) and the RSSI on the received packet is −60 (dBm) then the total pathloss is +4−(−60)=+64 dB. If a second packet were received at −40 dBm with a Tx Power Level data=+15 dBm the resulting pathloss would be +55 dB. An application may use these pathloss values to choose which device it thinks might be closer (the one with the lower pathloss value).

Unfortunately, due to fading and varying antenna, circuit, and chip characteristics, these resulting pathloss values may have some uncertainty. Some of the uncertainty (for example, due to fading) may be able to be alleviated if multiple packets are received from the same device.

IV. Bluetooth™ Host Controller Interface

The Bluetooth™ radio in a device may include the host controller interface that provides a command interface between the host application in the device and the link layer of the Bluetooth™ radio, also referred to as the controller, to enable access to hardware status and control registers of the Bluetooth™ radio.

The host controller interface (HCI) is described in the Bluetooth™ Core 4.0 Specification. The Host will receive asynchronous notifications of HCI events from Host Controller Transport Layer. HCI events are used for notifying the Host when something occurs. When the Host discovers that an event has occurred, it will then parse the received event packet to determine which event occurred. The commands and events are sent between the Host and the Controller. These are grouped into logical groups by function.

The HCI provides a command interface between the host application in a device and the Bluetooth™ link layer, provides access to hardware status and control registers of the Bluetooth™ radio, and provides a uniform method of accessing the Bluetooth™ baseband capabilities.

Discovery Phase HCI Commands and Events

HCI LE Advertising Report Event

The Bluetooth LE device discovery group of commands and events allow a device to discover other devices in the surrounding area. The Bluetooth LE host controller interface includes the HCI LE Advertising Report event that indicates that a Bluetooth device or multiple Bluetooth devices have been detected during an active scan or during a passive scan.

Connection Phase HCI Commands and Events

HCI LE Read Advertising Channel Tx Power Command

The TX Power Level is reported to the host in response to the HCI LE Read Advertising Channel Tx Power Command. The TX Power Level data field may be used to calculate path loss of a received packet when the receiving device measures the RSSI of the received advertising packet.

After the discovery phase is completed, once a Bluetooth device is connected to another Bluetooth device, the received signal strength indication (RSSI) may be used by a receiving device to monitor the received power level of the data communication packets received over the connection. The RSSI value is calculated by the Bluetooth physical layer, and may be read by the host application through the host controller interface (HCI) Read RSSI command.

The Read RSSI command will read the value of the received signal strength indication (RSSI) for data communication packets received over the connection to another Bluetooth controller. The RSSI value is referenced with respect to a Connection_Handle that identifies the connection and is assigned when the connection is created. The Connection_Handle is used by the Bluetooth controller to determine which set of buffers to use and the logical link over which the data is to be sent.

The RSSI parameter in the Read RSSI command is a signed 8-bit value, and is interpreted as an indication of arriving signal strength at the antenna measured in dBm. This command reads the Received Signal Strength Indication (RSSI) value from the Controller. For Bluetooth LE transport, a Connection_Handle is used as the Handle command parameter and return parameter. The meaning of the RSSI metric is an absolute receiver signal strength value in dBm to ±6 dBm accuracy.

The RSSI parameter returns the difference between the measured Received Signal Strength Indication (RSSI) and the limits of the Golden Receive Power Range for a Connection Handle to another Controller. Any positive RSSI value returned by the Controller indicates how many dB the RSSI is above the upper limit, any negative value indicates how many dB the RSSI is below the lower limit. The value zero indicates that the RSSI is inside the 20 dB-wide Golden Receive Power Range. The accuracy of the dB values will depend on the Bluetooth hardware. The only requirements for the hardware are that the Controller is able to tell whether the RSSI is inside, above or below the Golden Device Power Range. The RSSI measurement compares the received signal power with two threshold levels, which define the Golden Receive Power Range. The lower threshold level corresponds to a received power between −56 dBm and 6 dB above the actual sensitivity of the receiver. The upper threshold level is 20 dB above the lower threshold level to an accuracy of +/−6 dB. The meaning of the RSSI metric is an absolute receiver signal strength value in dBm to ±6 dBm accuracy. If the RSSI cannot be read, the RSSI metric is set to 127. (When the Read_RSSI command has completed, a Command Complete event is generated.)

V. Bluetooth LE Proximity Profile

The Proximity Profile defines the behavior when a device moves away from a peer device so that the connection is dropped or the path loss increases above a preset level, causing an immediate alert. This alert may be used to notify the user that the devices have become separated. As a consequence of this alert, a device may take further action, for example to lock one of the devices so that it is no longer usable.

The Proximity Profile may also be used to define the behavior when the two devices come closer together such that a connection is made or the path loss decreases below a preset level.

The Proximity Profile defines two profile roles to enable devices to detect their proximity: the Proximity Reporter and the Proximity Monitor. The Proximity Reporter is a Generic Attribute Profile (GATT) server on the one device in the connection, which supports a Link Loss Service (mandatory), an Immediate Alert Service (optional), and a transmit (Tx) Power Service (optional). The Proximity Monitor is a GATT client on the peer device in the connection, which monitors the Radio Signal Strength Information (RSSI) of the connection to calculate the signal's path loss. The Proximity Monitor may use the information received from the Proximity Reporter's Tx Power Service to normalize the RSSI value, by subtracting the RSSI from the Tx Power Level. In order to trigger an alert on low RSSI, the Proximity Monitor constantly monitors RSSI.

The Proximity Monitor on one device may maintain a connection with the Proximity Reporter on the peer device and monitor the RSSI of this connection. The Proximity Monitor may calculate the path loss by subtracting the RSSI from the transmit power level of the device of the Proximity Reporter, as discovered using the Reading Tx Power procedure. If the path loss exceeds a threshold set on the Proximity Monitor, it may write in the Alert Level characteristic of the Immediate Alert service, using the GATT Write Without Response sub-procedure, to cause the Proximity Reporter to generate an alert. The Proximity Monitor may also generate an alert when the path loss exceeds the threshold. The duration of the alert may be implementation specific.

The Proximity Monitor specified in the Bluetooth Proximity Profile, may include the following functions:
Service Discovery from the peer device;
Characteristic Discovery from the peer device;
Configuration of Alert on Link Loss to the peer device;
Alert on Link Loss to the peer device;
Reading Tx Power from the peer device; and
Alert on Path Loss locally and to the peer device based on RSSI supervision.

If the path loss falls below a threshold set on the Proximity Monitor it may write in the Alert Level characteristic of the Immediate Alert service, using the GATT Write Without Response sub-procedure, to cause the Proximity Reporter to end the alert. When the path loss is below the threshold the Proximity Monitor should stop alerting.

If link loss occurs during this procedure, then the behavior defined in the Alert on Link Loss procedure may be used.

VI. Reducing Power Consumption for Bluetooth LE Proximity Profile

Proximity profile is a standard Bluetooth LE energy profile. The proximity is determined based on received signal strength indication (RSSI) in the Proximity Monitor. According with Proximity Profile specification “ . . . the Proximity Monitor shall maintain a connection with the Proximity Reporter and monitor the RSSI of this connection. The Proximity Monitor shall calculate the path loss by subtracting the RSSI from the transmit power level of the Proximity Reporter as discovered using the Reading Tx Power procedure.”

The Bluetooth Low Energy stack is divided in two parts: Controller and Host. The Bluetooth standard specifies that the Proximity Profile is to be implemented in the Host part of the stack. The Host in one device, needs to wake up every few seconds to read the RSSI level of the connection with the peer device. This repeated awakening of the Host consumes excessive charge in the battery of the device. Normally the Host wakes up for an occasional handling of Bluetooth LE events reported by Controller, such as new connection events, disconnections, GATT/GAP messages, and the like. However, the repetitive monitoring of the RSSI by the Host consumes power because the Host must be active every few seconds for determining whether or not the peer device is in-range.

In accordance with an example embodiment of the invention, the RSSI supervision and handling functions of the Proximity Monitor are implemented in the Controller. In this approach, the Proximity Profile configures the Controller with the proximity settings so that the RSSI data may be analyzed in the Controller. The Host and the Controller may only exchange critical proximity data using new HCI commands and events. The two parts of the Proximity profile may communicate by using new HCI commands and events. In this way the Host will wake up rarely for handling proximity commands and events.

Monitoring of the RSSI values in the Controller will not create excessive power consumption, when compared with the existing monitoring of the RSSI values in the Host.

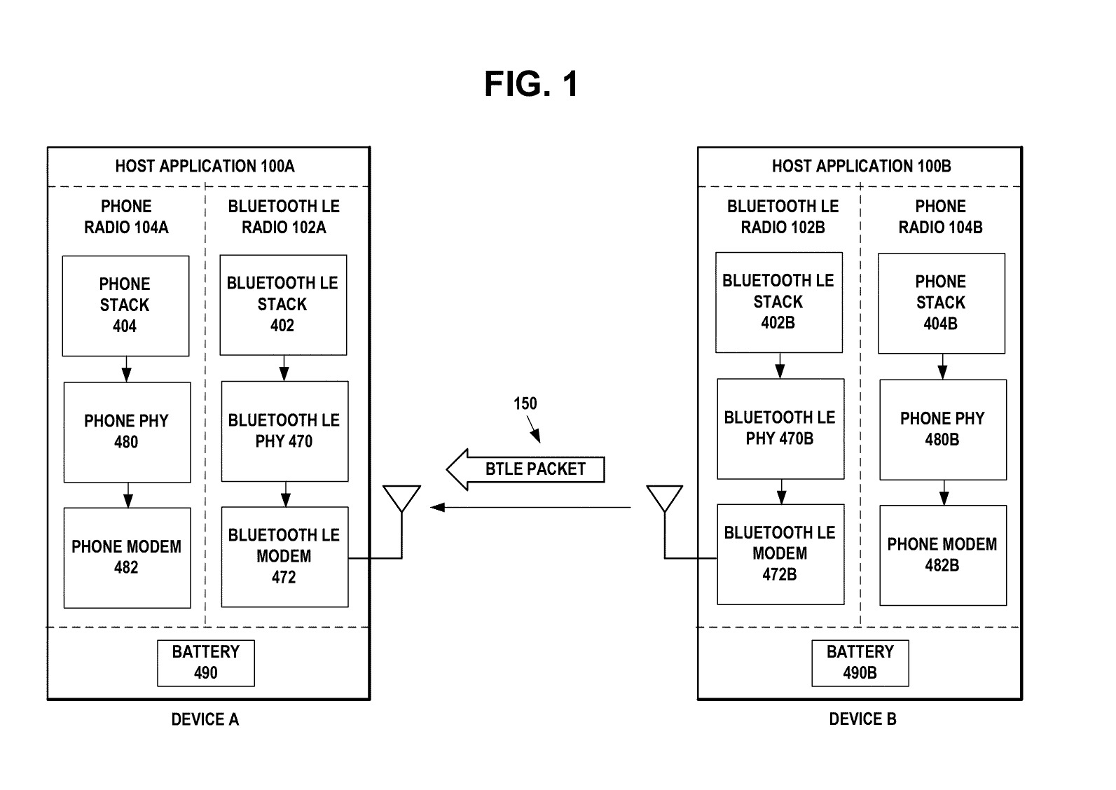

FIG. 1 is an example network diagram of two Bluetooth LE-enabled smart phones, with a first smart phone communication device A receiving a Bluetooth LE packet 150 from the second smart phone communication device B and determining the proximity based on received signal strength indication (RSSI) of the packet 150, in accordance with at least one embodiment of the present invention. Bluetooth LE-enabled smart phone Device A may include a host application 100A, a Bluetooth LE radio 102A, a phone radio 104A, and a battery 490. The Bluetooth LE radio 102A may include a Bluetooth LE protocol stack 402, a Bluetooth LE PHY layer 470, and a Bluetooth LE modem 472. The phone radio 104A may include a phone protocol stack 404, a phone PHY layer 480, and a phone modem 482 The second smart phone communication device B may include substantially the same type of components.

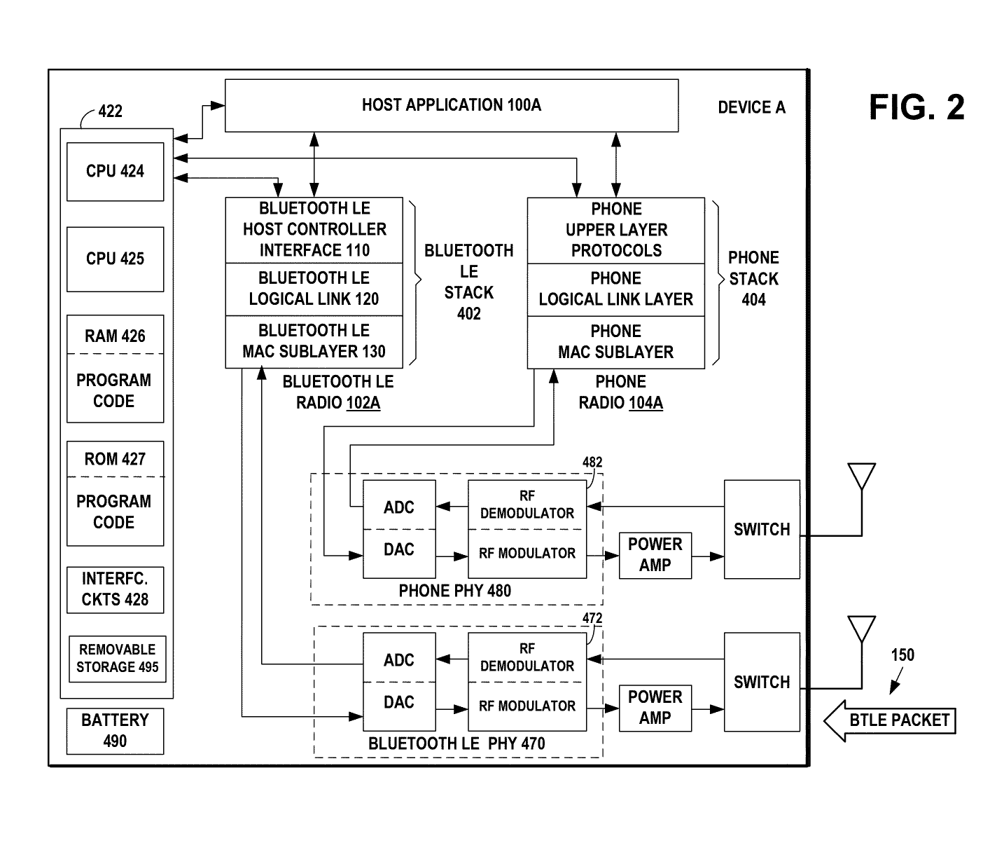

FIG. 2 is an example functional block diagram of the first Bluetooth LE-enabled smart phone communications device A, illustrating the host application 100A, the Bluetooth LE protocol stack 402, the phone protocol stack 404, and the battery 490, in accordance with at least one embodiment of the present invention. Communications device A may include an example radio embodiment with a wireless communications protocol such as the Bluetooth LE radio 102A. The Bluetooth LE protocol stack 402 in the Bluetooth LE radio 102A, in example embodiments, may include Bluetooth host controller interface (HCI) upper layer protocols 110, Bluetooth LE logical link layer controller 120, and Bluetooth LE MAC sublayer 130. The protocol stack 402 may have its digital baseband transmission path outputting its signal to the physical layer (PHY) radio 470. On the receive side, the radio 470 outputs the received signal to the digital baseband transmission path of the protocol stack 402, according to an embodiment of the present invention.

The example Bluetooth LE protocol stack 402 in example embodiments may have the digital baseband transmission path of the Bluetooth LE MAC sublayer 130 output the digital baseband signal through PHY logic 470 to a digital-to-analog converter and transmitter of an example radio frequency (RF) radio 470. The modulated output of the RF radio 470 from modem 472, may be amplified by a power amplifier (AMP) and applied to a transmit/receive switch and the antenna of the Bluetooth link. In receiving signals, such as Bluetooth LE packet 150, on the antenna of the Bluetooth link, the transmit/receive switch passes the RF signal to the receiver of the RF radio 470 and an analog-to-digital converter. The demodulated digital baseband signal then passes through PHY layer logic 470 to the Bluetooth LE MAC sublayer 130 of the Bluetooth LE protocol stack 402.

The first Bluetooth LE-enabled smart phone communications device A, is also shown including the phone protocol stack 404. The phone protocol stack 404 may include phone upper layer protocols, phone logical link layer, and phone MAC sublayer. The phone protocol stack 404 is shown connected to the host application 100A, the processor 422, the phone PHY layer 480, and the modem 482 to the phone wireless link.

The communications device A may include a processor 422, which may include a single core CPU or multiple core central processing unit (CPU) 424 and 425, a random access memory (RAM) 426, a read only memory (ROM) 427, and interface circuits 428 to interface with one or more radio transceivers, battery or house power sources, keyboard, display, key pad, touch screen, display, microphone, speakers, ear pieces, camera or other imaging devices, etc. The RAM and ROM may be removable memory devices 495 such as smart cards, SIMs, WIMs, semiconductor memories such as RAM, ROM, PROMS, flash memory devices, etc.

An example embodiment of the host application 100A, HCI upper layer protocols, and the Bluetooth stack LE 402, may be computer program code instructions stored in the RAM 426 and/or ROM 427 memory of the processor 422, which when executed by the central processing units (CPU) 424 and or 425, carry out the functions of the example embodiments of the invention. Alternately, some or all of these instructions may be embodied as hardware program logic included in programmed logic arrays of sequential and/or combinatorial logic circuits and/or state machine logic implementing some or all of the steps performed by embodiments of the invention.

Examples of such telephone protocols represented by the phone protocol stack 404 may include, for example, cellular protocols such as Global System for Mobile Communications (GSM), Wideband Code Division Multiple Access (W-CDMA), High Speed Packet Access (HSPA), Long Term Evolution (LTE), LTE Advanced (LTE-A), International Mobile Telecommunications Advanced (IMT-A), CDMA, Wireless Metropolitan Area Networks (WMAN) and Broadband Wireless Access (BWA) (LMDS, WiMAX, AIDAAS and HiperMAN), or the like networks.

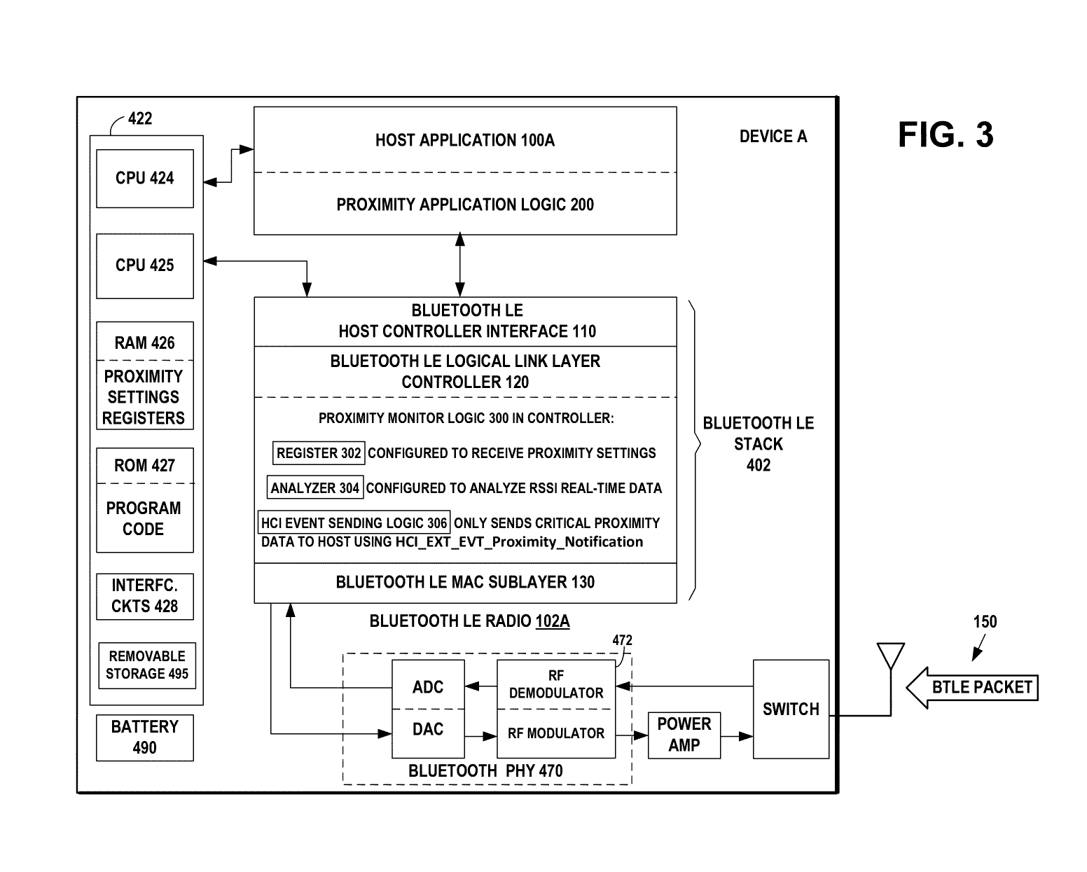

FIG. 3 is a more detailed example functional block diagram of the first Bluetooth LE-enabled smart phone, Device A, of FIG. 2, illustrating the RSSI supervision and handling functions 310 of the Proximity Monitor implemented in the Bluetooth LE logical link controller 120, in accordance with at least one embodiment of the present invention. The Host and the Controller may only exchange critical proximity data using new HCI commands and events. The two parts of the Proximity profile may communicate by using new HCI commands and events. In this way the Host will wake up rarely for handling proximity commands and events.

The Bluetooth LE logical link controller 120 is configured to load proximity settings into register 302. The proximity settings may be RSSI threshold values. The RSSI threshold values may represent the limits of the Golden Receive Power Range for a Connection Handle to another Controller in Device B. The RSSI threshold values may be used for determining proximity of a peer wireless communication device B, based on received signal strength indication (RSSI) of wireless signals received from the peer wireless communication device. The proximity settings are loaded by the controller 120 into register 302, in response to an HCI command from the proximity application logic 200 in the host 100A, for example, HCI_EXT_CMD_Set Proximity Thresholds.

The analyzer 304 in the Bluetooth LE logical link controller 120, is configured to analyze real-time received signal strength indication (RSSI) measurement data of wireless signals received from the peer wireless communication device B. Any positive RSSI value indicates how many dB the RSSI is above the upper limit of the proximity settings, any negative value indicates how many dB the RSSI is below the lower limit of the proximity settings. The value zero indicates that the RSSI is inside the 20 dB-wide Golden Receive Power Range. The RSSI measurement compares the received signal power with two threshold levels of the proximity settings, which define the Golden Receive Power Range. The lower threshold level corresponds to a received power between −56 dBm and 6 dB above the actual sensitivity of the receiver. The upper threshold level is 20 dB above the lower threshold level to an accuracy of +/−6 dB. The meaning of the RSSI metric is an absolute receiver signal strength value in dBm to ±6 dBm accuracy.

The HCI event sending logic 306 in the Bluetooth LE logical link controller 120, is configured to send to the proximity application logic 200 in the host 100A, an HCI event reporting only critical proximity events resulting from the analysis of the real-time received signal strength indication (RSSI) measurement data, based on the proximity settings for determining proximity of the peer wireless communication device. The host control interface (HCI) event is a proximity notification event reporting a status change in proximity based on an RSSI threshold indicating either an in-range proximity or an out-of-range proximity. The critical proximity events are sent to the host in an HCI event, for example HCI_EXT_EVT_Proximity_Notification.

In accordance with an example embodiment of the invention, the RSSI supervision and handling functions 310 of the Proximity Monitor implemented in the Bluetooth LE logical link controller 120 include:

receiving and loading proximity settings into register 302;

analyzing real-time received signal strength indication (RSSI) measurement data of received wireless signals; and
sending to the proximity application logic 200 in the host 100A, an HCI event reporting only critical proximity events resulting from the analysis of the real-time received signal strength indication (RSSI) measurement data, based on the proximity settings for determining proximity of the peer wireless communication device.

In accordance with an example embodiment of the invention, the RSSI supervision and handling functions 310 of the Proximity Monitor are implemented in the Bluetooth LE logical link controller 120. The proximity application logic 200 in the host 100A may retain one or more of the other Proximity Monitor functions:
Service Discovery from the peer device;
Characteristic Discovery from the peer device;
Configuration of Alert on Link Loss to the peer device;
Alert on Link Loss to the peer device; and
Reading Tx Power from the peer device.

The Bluetooth LE device A and device B may be a Bluetooth enabled communications device, PDA, cell phone, laptop or palmtop computer, or the like or it may be a stationary access point, automotive dashboard interface, home electronics interface or other Bluetooth enabled stationary interface or device. The Bluetooth LE device A and device B may be a Bluetooth enabled remote controller, healthcare monitor, sports sensor, token, key fob, watch, wireless keyboard, gaming pad, body sensor, toy, health care equipment, human interface device, entertainment device, wireless microphone, GPS sensor, or the like.

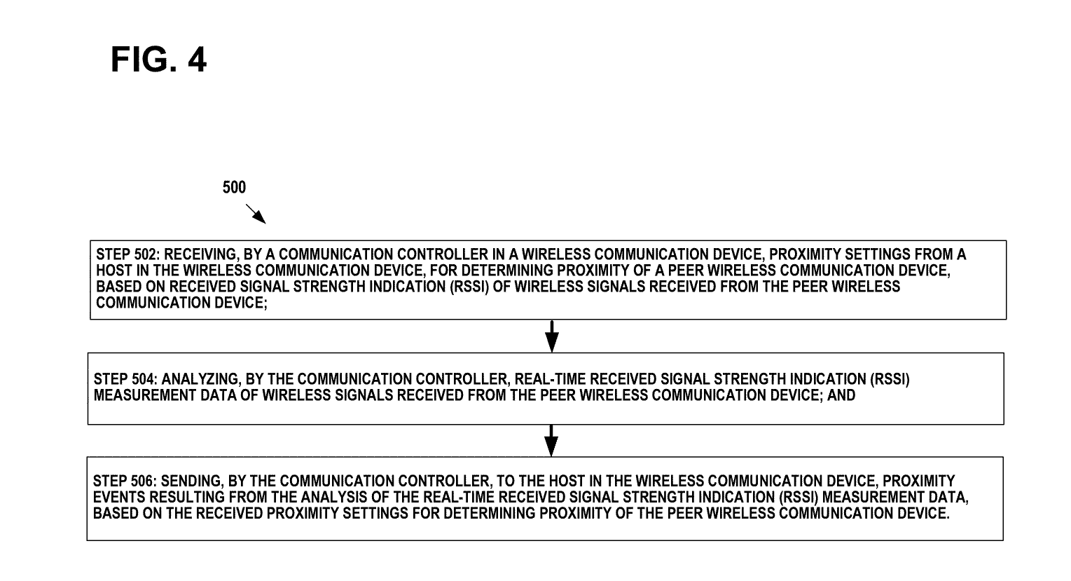

FIG. 4 is an example embodiment of a flow diagram 500 of a method performed by the Bluetooth LE logical link controller, in accordance with an example embodiment of the invention. The steps of the flow diagram represent computer code instructions stored in the RAM and/or ROM memory, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 502: receiving, by a communication controller in a wireless communication device, proximity settings from a host in the wireless communication device, for determining proximity of a peer wireless communication device, based on received signal strength indication (RSSI) of wireless signals received from the peer wireless communication device;

Step 504: analyzing, by the communication controller, real-time received signal strength indication (RSSI) measurement data of wireless signals received from the peer wireless communication device; and

Step 506: sending, by the communication controller, to the host in the wireless communication device, proximity events resulting from the analysis of the real-time received signal strength indication (RSSI) measurement data, based on the received proximity settings for determining proximity of the peer wireless communication device.

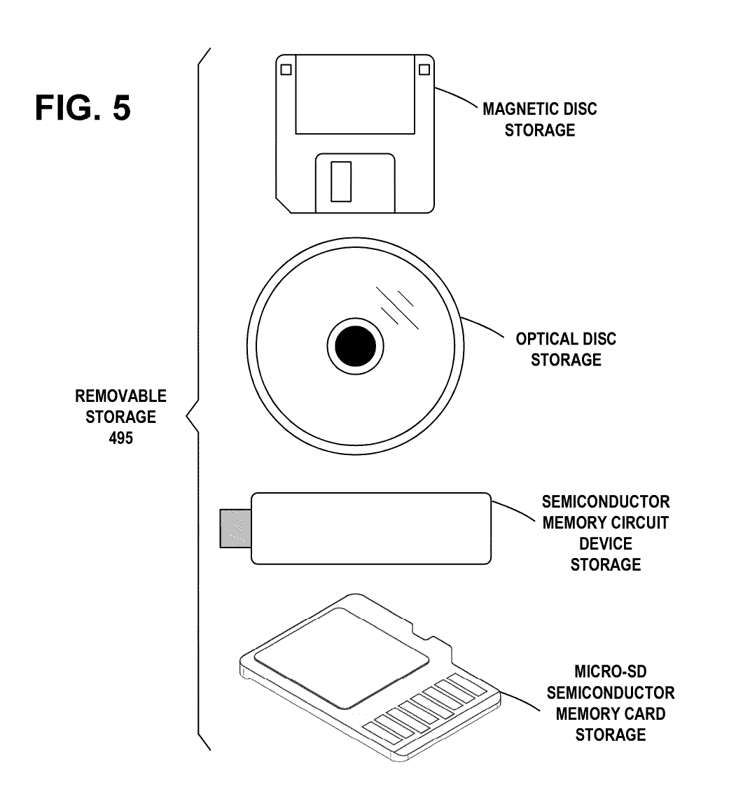

FIG. 5 illustrates an example embodiment of the invention, wherein examples of removable storage media 495 are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

Example host control interface (HCI) events and commands exchanged between the host application 100A and the Bluetooth LE logical link layer controller 120 are shown in Tables A and B. Table A illustrates HCI Commands (Host 100A to Controller 120 Messages), in accordance with an example embodiment of the invention. Table B illustrates HCI Events (Controller 120 to Host 100A Messages), in accordance with an example embodiment of the invention.

TABLE A
HCI Commands (Host to Controller Messages)

| | | Return | | |
|---|---|---|---|---|
| HCI Command | Parameters | Parameters | What it does | Required |
| HCI_EXT_CMD_Set_Algorithm | Connection | None | Using this command the Host sets the RSSI | Optional |
| | Handle | | filtering algorithm for a certain Bluetooth | |
| | Algorithm | | LE connection. The Controller implements a | |
| | | | default filtering algorithm. | |
| | | | This command is used to overwrite the default | |
| | | | implementation by application which require | |
| | | | special filtering algorithms. | |
| HCI_EXT_CMD_Set_Proximity_Thresholds | Connection | None | The Host sets the RSSI thresholds for this | Mandatory |
| | Handle | | connection by using this command. If the actual | |
| | RSSI value | | RSSI value becomes lower than a threshold from | |
| | | | the array, then the Host shall receive an | |
| | | | HCI_EXT_EVT_Proximity_Notification | |
| | | | from the Controller with OUT_OF_RANGE status. | |
| | | | On the contrary, if the RSSI value becomes higher | |
| | | | than the threshold than a threshold from the array, | |
| | | | the Host shall receive an | |
| | | | HCI_EXT_EVT_Proximity_Notification | |
| | | | with IN_RANGE status. | |
| HCI_EXT_CMD_Get_Proximity_Threshold | Connection | RSSI | It reads the RSSI thresholds for this connection. | Mandatory |
| | Handle | Threshold | | |
| HCI_EXT_CMD_Activate_Filtered_RSSI_Events | Connection | None | The Host shall receive all RSSI data from the | Optional |
| | Handle | | Controller in real time after this command is | |
| | | | invoked. The RSSI values are provided according | |
| | | | with the filtering algorithm. This is useful for | |
| | | | instance when the user can see real time RSSI | |
| | | | updates in the phone’s UI. | |
| HCI_EXT_CMD_Deactivate_Filtered_RSSI_Events | Connection | None | The Host shall stop receiving all filtered RSSI | Optional |
| | Handle | | data from the Controller in real time. | |
| HCI_EXT_CMD_Set_Algorithm | Connection | None | Using this command the Host sets the RSSI | Optional |
| | Handle | | filtering algorithm for a certain Bluetooth | |
| | Algorithm | | LE connection. The Controller implements a | |
| | | | default filtering algorithm. | |
| | | | This command is used to overwrite the default | |
| | | | implementation by application which require | |
| | | | special filtering algorithms. | |
| HCI_EXT_CMD_Set_Proximity_Thresholds | Connection | None | The Host sets the RSSI thresholds for this | Mandatory |
| | Handle | | connection by using this command. If the actual | |
| | RSSI value | | RSSI value becomes lower than a threshold from | |
| | | | the array, then the Host shall receive an | |
| | | | HCI_EXT_EVT_Proximity_Notification | |
| | | | from the Controller with OUT_OF_RANGE status. | |
| | | | On the contrary, if the RSSI value becomes higher | |
| | | | than the threshold than a threshold from the array, | |
| | | | the Host shall receive an | |
| | | | HCI_EXT_EVT_Proximity_Notification | |
| | | | with IN_RANGE status. | |
| HCI_EXT_CMD_Get_Proximity_Threshold | Connection | RSSI | It reads the RSSI thresholds for this connection. | Mandatory |
| | Handle | Threshold | | |
| HCI_EXT_CMD_Activate_Filtered_RSSI_Events | Connection | None | The Host shall receive all RSSI data from the | Optional |
| | Handle | | Controller in real time after this command is | |
| | | | invoked. The RSSI values are provided according | |
| | | | with the filtering algorithm. This is useful for | |
| | | | instance when the user can see the real time RSSI | |
| | | | updates in the phone's UI. | |
| HCI_EXT_CMD_Deactivate_Filtered_RSSI_Events | Connection | None | The Host shall stop receiving all filtered RSSI | Optional |
| | Handle | | data from the Controller in real time. | |

TABLE B
HCI Events (Controller to Host Messages)

| HCI Event | Parameters | What it does | Required |
|---|---|---|---|
| HCI_EXT_EVT_Proximity_Notification | Connection Handle | This event reports a status change in the | Mandatory |
| | Proximity Status | proximity depending on the RSSI threshold. | |
| | (OUT_OF_RANGE, | Possible values for the status are: IN RANGE | |
| | IN_RANGE) | or OUT OF RANGE. | |
| | RSSI Threshold Value | | |
| HCI_EXT_EVT_New | Connection Handle | This event carries the RSSI value updates for | Mandatory |
| RSSI_Value_Notification | RSSI Type (Filtered | a certain connection. This event can be | |
| | or Unfiltered) | activated or deactivated by | |
| | RSSI value | HCI_EXT_CMD_Activate_Filtered_RSSI_Events/ | |
| | | HCI_EXT_CMD_Activate_Filter_RSSI_Events | |
| | | and | |
| | | HCI_EXT_CMD_Activate_Unfiltered_RSSI_Events/ | |
| | | HCI_EXT_CMD_Activate_Unfilter_RSSI_Events. | |
| HCI_EXT_EVT_RSSI_Value_Read | Connection Handle | This event carries the value of RSSI value for | Mandatory |
| | RSSI Type (Filtered | a certain connection. This event comes after invoking | |
| | or Unfiltered) | HCI_EXT_CMD_Read_RSSI_Filtered_Value_Request and | |
| | RSSI value | HCI_EXT_CMD_Read_RSSI_Unfiltered_Value_Request | |
| | | commands. | |

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc.

Although specific example embodiments have been disclosed, a person skilled in the art will understand that changes can be made to the specific example embodiments without departing from the spirit and scope of the invention.

What is claimed is:

1. A method, comprising:
receiving, by a communication controller in a wireless communication device, proximity settings, from a host in the wireless communication device, for determining proximity of a peer wireless communication device, based on received signal strength indication (RSSI) of wireless signals received from the peer wireless communication device;
analyzing, by the communication controller, real-time received signal strength indication (RSSI) measurement data of wireless signals received from the peer wireless communication device; and
sending, by the communication controller, to the host in the wireless communication device, proximity events resulting from the analysis of the real-time received signal strength indication (RSSI) measurement data, based on the received proximity settings for determining proximity of the peer wireless communication device.

2. The method of claim 1, wherein the communication controller, sends only critical proximity events to the host in the wireless communication device, resulting from the analysis of the real-time received signal strength indication (RSSI) measurement data, based on the received proximity settings for determining proximity of the peer wireless communication device.

3. The method of claim 2, wherein the communication controller is a Bluetooth Low Energy logical link layer controller.

4. The method of claim 3, wherein the critical proximity events are host control interface (HCI) events.

5. The method of claim 4, wherein the host control interface (HCI) event is a proximity notification event reporting a status change in proximity based on an RSSI threshold indicating either an in-range proximity or an out-of-range proximity.

6. The method of claim 5, wherein the communication controller receives the proximity settings from the host using a host control interface (HCI command.

7. An apparatus, comprising:
at least one processor;
at least one memory including computer program code;
the at least one memory and the computer program code configured to, with the at least one processor, cause the apparatus at least to:
receive, in a wireless communication device, proximity settings, from a host in the wireless communication device, for determining proximity of a peer wireless communication device, based on received signal strength indication (RSSI) of wireless signals received from the peer wireless communication device;
analyze real-time received signal strength indication (RSSI) measurement data of wireless signals received from the peer wireless communication device; and
send to the host in the wireless communication device, proximity events resulting from the analysis of the real-time received signal strength indication (RSSI) measurement data, based on the received proximity settings for determining proximity of the peer wireless communication device.

8. The apparatus of claim 7, wherein the communication controller, sends only critical proximity events to the host in the wireless communication device, resulting from the analysis of the real-time received signal strength indication (RSSI) measurement data, based on the received proximity settings for determining proximity of the peer wireless communication device.

9. The apparatus of claim 8, wherein the apparatus is a Bluetooth Low Energy logical link layer controller.

10. The apparatus of claim 9, wherein the critical proximity events are host control interface (HCI) events.

11. The apparatus of claim 10, wherein the host control interface (HCI) events are proximity notification events reporting status change in proximity based on an RSSI threshold proximity setting indicating either an in-range proximity or an out-of-range proximity.

12. The apparatus of claim 11, wherein the apparatus receives the proximity settings from the host using a host control interface (HCI) command.

13. A computer program product comprising computer executable program code recorded on a computer readable non-transitory storage medium, the computer executable program code comprising:
code for receiving, by a communication controller in a wireless communication device, proximity settings, from a host in the wireless communication device, for determining proximity of a peer wireless communication device, based on received signal strength indication (RSSI) of wireless signals received from the peer wireless communication device;
code for analyzing, by the communication controller, real-time received signal strength indication (RSSI) measurement data of wireless signals received from the peer wireless communication device; and
code for sending, by the communication controller, to the host in the wireless communication device, proximity events resulting from the analysis of the real-time received signal strength indication (RSSI) measurement data, based on the received proximity settings for determining proximity of the peer wireless communication device.

14. The computer program product of claim 13, wherein the communication controller, sends only critical proximity events to the host in the wireless communication device, resulting from the analysis of the real-time received signal strength indication (RSSI) measurement data, based on the received proximity settings for determining proximity of the peer wireless communication device.

15. The computer program product of claim 14, wherein the communication controller is a Bluetooth Low Energy logical link layer controller.

16. The computer program product of claim 15, wherein the critical proximity events are host control interface (HCI) events.

17. The computer program product of claim 16, wherein the host control interface (HCI) event is a proximity notification event reporting a status change in proximity based on an RSSI threshold indicating either an in-range proximity or an out-of-range proximity.

18. The computer program product of claim 17, wherein the communication controller receives the proximity settings from the host using a host control interface (HCI command.
